(19) United States
(12) Patent Application Publication
(10) Pub. No.: US 2013/0323433 A1
(43) Pub. Date: Dec. 5, 2013

(54) PLATING METHOD USING LASER ETCHING PROCESS

(71) Applicant: HYUNDAI MOTOR COMPANY, Seoul (KR)

(72) Inventor: Chang-Sup Lee, Hwasung (KR)

(73) Assignee: HYUNDAI MOTOR COMPANY, Seoul (KR)

(21) Appl. No.: 13/724,654

(22) Filed: Dec. 21, 2012

(30) Foreign Application Priority Data
May 31, 2012 (KR) 10-2012-0058296

(51) Int. Cl. B05D 3/06

(52) U.S. Cl. CPC B05D 3/06
USPC 427/555

(57) ABSTRACT

Disclosed is a method for plating on a nickel plated layer using a laser etching process including: forming a nickel plated layer on the surface of a raw material; forming a laser etched layer by laser etching a graphic on the nickel plated layer; and forming a chromium plated layer on the laser etched layer.

### CROSS-REFERENCE TO RELATED APPLICATION

This application claims priority under 35 U.S.C. §119 to Korean Patent Application No. 10-2012-58296, filed on May 31, 2012, in the Korean Intellectual Property Office, the disclosure of which is incorporated herein by reference in its entirety.

### BACKGROUND

(a) Technical Field

The present invention relates to a plating method for material surface treatment, more particularly, to a plating method for embodying a graphic without lowering appearance, corrosion resistance, wear resistance and the like by laser etching a certain nickel plated layer and forming a typical plated layer such as a MP (microporous) nickel plated layer and a chromium plated layer on the laser etched nickel plated layer.

(b) Background Art

Generally, industrial product production of metal based componens consists of entering raw materials, injection molding, plating, coating/assembling and shipping. Specifically, plating is a surface treatment of coating a thin layer of other material on the raw material to improve the surface state of the raw materials, in which a thin metal layer is coated on the material surface. Furthermore, the surface treatment may improve corrosion resistance, wear resistance and the like of the raw materials and effects such as gloss and texture may be obtained.

To provide the effects, various types of plating method are used, and particularly, chromium plating is widely used as finish plating (e.g., final plating) for decorative plating due to its high hardness, gloss and low discoloration in the air. Further, due to its high wear resistance, the chromium plating is used as hard chromium plating (e.g., engineering chromium plating) for machine parts, molds, tools and the like.

In addition, a method, in which glossy or matte of the chromium plating may be selected using a glossy or matte nickel plated layer, is used, and FIG. 1 is an exemplary view of a plated structure according to the glossy or matte chromium plating method as described above in the related art.

The conventional glossy or matte chromium plating methods for raw materials such as

Acryloniiriie-Butadiene-Styrene (ABS) resin is generally conducted by a chemical plating method or an electro plating method. The chemical plating method is a plating method in which a material to be plated is soaked in a chemical plating solution, wherein the current is off, unlike the electro plating. The electro plating method is a method of coating the raw material surface with another metal using deposition according to electrolysis.

To perform the glossy or matte chromium plating method, the raw material A is processed followed etching and activation by the chemical plating method for securing adherence of the raw material A and the plated layer. The etching is a process of soaking the degreased and acid treated material in an acid solution for a short period of time to remove an invisible oxide film on the metal surface. The activation is a treatment for destroying the passive state on the surface or a treatment of adsorbing catalytic metal on the surface for electroless plating on a non metal material; and these methods are commonly conducted as a pretreatment of the plating. Furthermore, to provide conductivity for the electro plating, a chemical nickel plated layer B of about 0.2-0.4 μm thick is formed.

Following the chemical plating method, the electro plating method is performed to form: a copper plated layer C of about 10˜30 μm thick for buffering performance absorbing impact; a semi-glossy nickel plated layer D of about 10˜20 μm thick for anti-corrosion and high voltage; a glossy or matte nickel plated layer E of about 8˜12 μm thick for “glossy” or “matte” effect, anti-corrosion and low voltage; a MP nickel plated layer F of 0.8˜1.2 μm thick for corrosion current dispersion; and a chromium plated layer G of about 0.15˜0.5 μm thick for appearance, corrosion resistance and wear resistance.

Moreover, when the nickel plated layer E of about 8˜12 μm thick is glossy, it is classified into the glossy chromium plating method, and when it is matte, it is classified into the matte chromium plating method.

Further, as the copper plated layer C and the MP nickel plated layer F are included into the entire plated layer, the physical properties of the plating may be further improved.

However, when a graphic was etched by laser etching on the surface of the material completed by the conventional glossy or matte chromium plating method, the chromium plated layer G or the MP nickel plated layer F could be damaged by the laser etching process and thereby appearance, corrosion resistance, wear resistance and the like could be decreased. In addition, when the chromium plated layer G was a colored chromium plated layer G such as a white chromium plated layer or a dark chromium plated layer, a part of or the entire colored chromium plated layer could be damaged by the laser etching process and thereby the desired color effect or dependability could be not obtained.

Further, recently, despite relative importance of glossy characteristic of the material surface for customer's product selection, the conventional glossy and matte plating method was limited to obtain product difference because only glossy or matte was provided but glossy level or matte level of a graphic was not controlled.

The description provided above as a related art of the present invention is just for helping understanding the background of the present invention and should not be construed as being included in the related art known by those skilled in the art.

### SUMMARY

The present invention provides a method for etching a graphic without defecting a nickel plated layer by a laser etching process on the nickel plated layer and forming a typical plated layer on the laser etched nickel plated layer formed by the laser etching process, wherein a brightness of the graphic is controlled by the etching thickness of the nickel plated layer.

The plating method of the present invention using a laser etching process includes: forming a nickel plated layer on the surface of a raw material; forming a laser etched layer by laser etching a graphic on the nickel plated layer; and forming a chromium plated layer on the laser etched layer.

In addition, forming the laser etched layer may further include removing contaminants resulting from the laser etching process and washing the surface by ultrasonic washing and electrolytic degrease after forming the laser etched layer. Furthermore, a copper plated layer is formed on the surface of the raw material and then the nickel plated layer is formed thereon.

Moreover, in forming a chromium plated layer, a MP (microporous) nickel plated layer is formed on the laser etched layer and the chromium plated layer is formed thereon.

On the other hand, the nickel plated layer may be a glossy nickel plated layer, a semi glossy nickel plated layer or a matte nickel plated layer. Further, the nickel played layer may include a semi glossy nickel plated layer and a glossy nickel plated layer formed on the semi glossy nickel plated layer; a semi glossy nickel plated layer and a matte nickel plated layer formed on the semi glossy nickel plated layer; a semi glossy nickel plated layer, a glossy nickel plated layer formed on the semi-glossy nickel plated layer and a matte nickel plated layer formed on the glossy nickel plated layer; and a semi-glossy nickel plated layer, a matte nickel plated layer formed on the semi-glossy nickel plated layer and a glossy nickel plated layer formed on the matte nickel plated layer.

Further, the thickness of the laser etched layer may be about 0.001 to 100 nm, and the chromium plated layer previously described may be a white chromium plated layer or a dark chromium plated layer.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary view of a plated structure according to the conventional glossy or matte chromium plating method;

FIG. 2 is an exemplary schematic diagram showing a plated structure according to the conventional glossy chromium plating method;

FIG. 3 is an exemplary diagram showing an exemplary embodiment according to the conventional glossy chromium plating method;

FIG. 4 is an exemplary schematic diagram showing a plated structure according to an exemplary embodiment of the present invention, including a graphic etched on glossy background;

FIG. 5 is an exemplary diagram showing a graphic on glossy background according to an exemplary embodiment of the present invention;

FIG. 6 is an exemplary diagram showing methods of a laser etching process, ultrasonic washing and electrolytic degrease of the multilayered-nickel plated layer comprising a glossy nickel plated layer 130 according to an exemplary embodiment of the present invention;

FIG. 7 is an exemplary schematic diagram showing the plated structure according to the conventional matte chromium plating method;

FIG. 8 is an exemplary diagram showing an embodiment according to the conventional matte chromium plating method;

FIG. 9 is an exemplary schematic drawing showing a plated structure according to an exemplary embodiment of the present invention, including a graphic etched on matte background;

FIG. 10 is an exemplary diagram showing a graphic on matte background according an exemplary embodiment of the present invention; and

FIG. 11 is an exemplary diagram showing methods of a laser etching process, ultrasonic washing and electrolytic degrease of the multilayered-nickel plated layer comprising a matte nickel plated layer 230 according to an exemplary embodiment of the present invention.

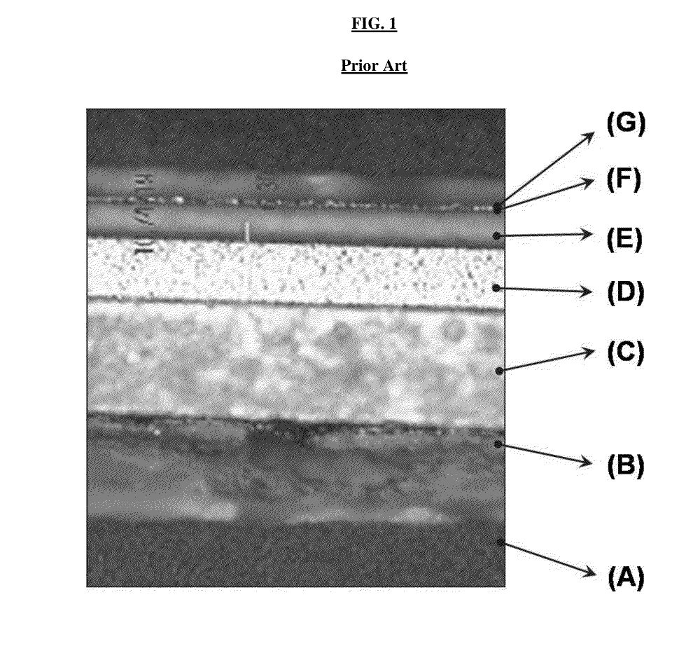

### DESCRIPTION OF SYMBOLS

| | |
|---|---|
| 10: Raw Material | 11: Copper Plated Layer |
| 12: Semi-glossy Nickel Plated Layer | 13: Glossy nickel Plated Layer |
| 14: MP Nickel Plated Layer | 15: Chromium Plated Layer |
| 20: Raw Material | 21: Copper Plated Layer |
| 22: Semi-glossy Nickel Plated Layer | 23: Matte Nickel Plated Layer |
| 24: MP nickel Plated Layer | 25: Chromium Plated Layer |
| 100: Raw Material | 110: Copper Plated Layer |
| 120: Semi-glossy Nickel Plated Layer | 130: Glossy nickel Plated Layer |
| 140: MP Nickel Plated Layer | 150: Chromium Plated Layer |
| 160: Laser Etched Layer | 200: Raw Material |
| 210: Copper Plated Layer | 220: Semi-glossy Nickel Plated |
| | Layer |
| 230: Matte Nickel Plated Layer | 240: MP nickel Plated Layer |
| 250: Chromium Plated Layer | 260: Laser Etched Layer |

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DESCRIPTION OF EXEMPLARY EMBODIMENTS

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the present invention now will be described in detail with reference to the accompanying drawings.

The plating method of the present invention using a laser etching process includes etches a graphic onto a material without lowering appearance, corrosion resistance, wear resistance and the like of the material by laser etching a nickel plated layer, such as a monolayered nickel plated layer or a multilayered-nickel plated layer. The graphic may be various visual images comprising letters and the like as well as pictures, figures, logos and photos, and the multilayered-nickel may be a nickel plated layer overlapped with 2˜3 layers having different sulfur contents.

Further, the laser etching process is a method of micro melting the material surface using a laser and intaglio treating (e.g., etching) thereof, and the process may embody sophisticated and detailed graphics by controlling density of laser spots. The laser may be a Neodymium-YAG laser, eximer laser, carbon dioxide laser and the like, and conditions such as usable frequency range, power range and laser spot may be controlled according to factors such as etching thickness.

Moreover, the monolayered nickel plated layer may be a glossy nickel plated layer; a semi glossy nickel plated layer; or a matte nickel plated layer. The multilayered nickel plated layer may include a nickel plated layer having a multi layered structure formed by a combination of several nickel plated layers having different gloss level, such as a semi glossy nickel plated layer and a glossy nickel plated layer formed on the semi glossy nickel plated layer; a semi glossy nickel plated layer and a matte nickel plated layer formed on the semi glossy nickel plated layer; a semi glossy nickel plated layer, a glossy nickel plated layer formed on the semi glossy nickel plated layer and a matte nickel plated layer formed on the glossy nickel plated layer; or a semi glossy nickel plated layer, a matte nickel plated layer formed on the semi-glossy nickel plated layer and a glossy nickel plated layer formed on the matte nickel plated layer.

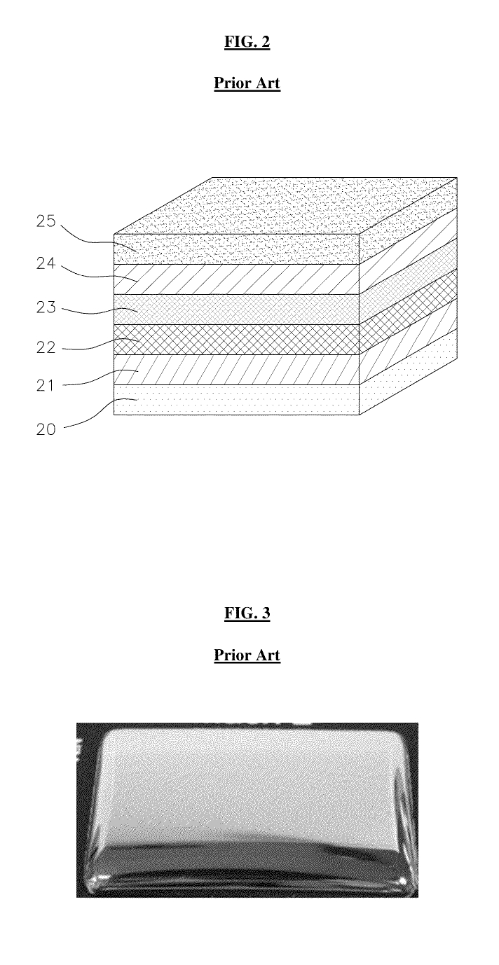

FIG. 2 is an exemplary schematic diagram showing a plated structure according to the conventional glossy chromium plating method, and FIG. 3 is an exemplary diagram showing an exemplary embodiment according to the conventional glossy chromium plating method.

Specifically, as shown in FIG. 2 and FIG. 3, the plating method according to the conventional glossy chromium plating method showed the raw material 10 having gloss on the glossy nickel plated layer 13 formed on the semi glossy nickel plated layer 12, and when a graphic was etched by the laser etching process on the chromium plated layer 15, the appearance, corrosion resistance, wear resistance and the like decreased due to the chromium plated layer 15 or the MP nickel plated layer 14 being removed. In addition, when the chromium plated layer 15 was a colored chromium plated layer 15 such as a white chromium plated layer or a dark chromium plated layer, the desired color effect was not obtained due to the colored chromium plated layer 15 being removed by the laser etching process.

However, the plating method according to the present invention etches a graphic onto the material layer without decreasing the appearance, corrosion resistance, wear resistance and the like by forming a laser etched layer by laser etching the nickel plated layer, (e.g., the monolayered nickel plated layer such as the glossy nickel plated layer, the semi-glossy nickel plated layer or the matte nickel plated layer, or on the multilayered nickel plated layer) followed by forming a common plated layer on the laser etched layer. Furthermore, the common plated layer may be a chromium plated layer, and may comprise a MP (microporous) nickel plated layer and a chromium plated layer formed on the MP nickel plated layer.

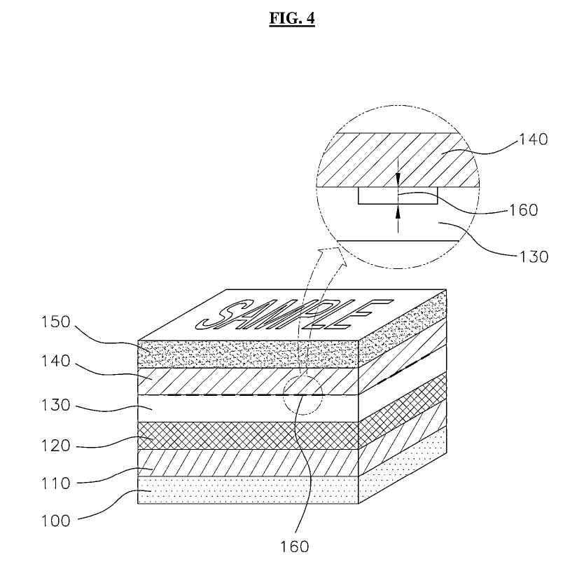

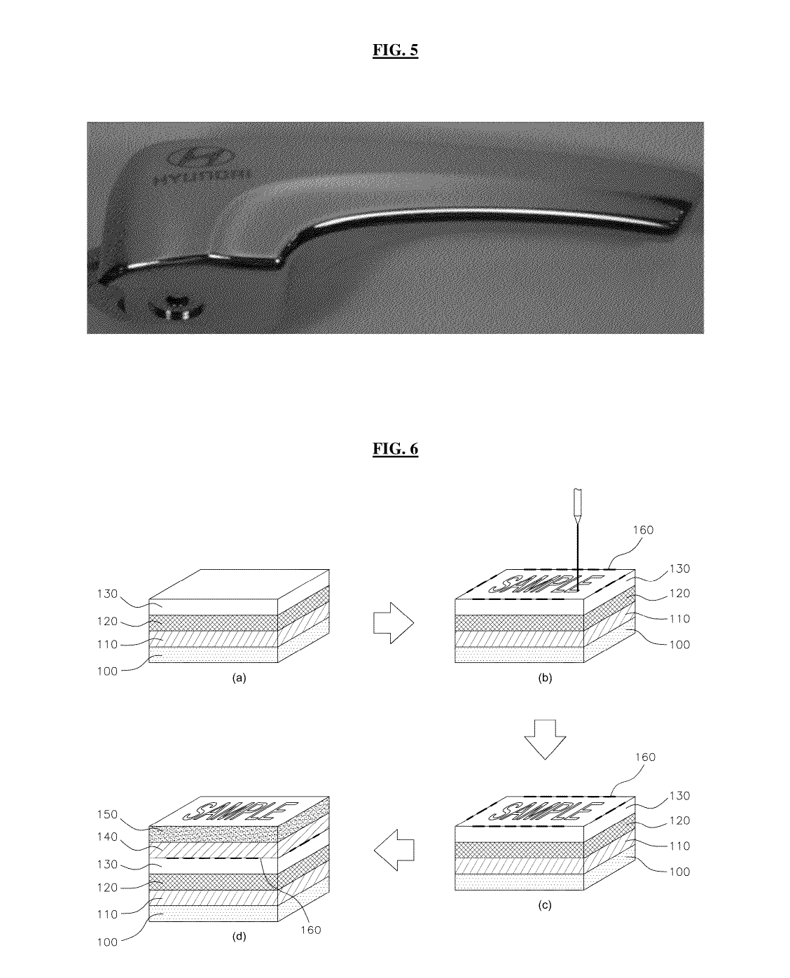

FIG. 4 is an exemplary schematic diagram showing a plated structure according to an exemplary embodiment of the present invention, having a graphic on a glossy background using a laser etching process on a multilayered-nickel plated layer comprising a semi glossy nickel plated layer and a glossy nickel plated layer formed on the semi glossy nickel plated layer, and the enlarged laser etched layer, and FIG. 5 is an exemplary diagram showing a graphic on glossy background according to an exemplary embodiment of the present invention.

As shown in FIG. 4 and FIG. 5, a graphic may be etched on a glossy background without decreasing appearance, corrosion resistance, wear resistance and the like by forming a laser etched layer 160 by laser etching a glossy nickel plated layer 130 and by forming a common plated layer such as a chromium plated layer on the laser etched layer 160.

FIG. 6 is an exemplary diagram showing methods of a laser etching process, ultrasonic washing and electrolytic degrease of the multilayered-nickel plated layer comprising a glossy nickel plated layer 130.

The nickel plated layer may be formed on the surface of the raw material 100, and a copper plated layer 110 and the like may be formed on the surface of the raw material 100 for buffering performance absorbing impact, prior to forming the nickel plated layer. (First step, a)

According to one embodiment of the present invention, the nickel plated layer of FIG. 6 may be a multilayered nickel plated layer comprising a semi glossy nickel plated layer and a glossy nickel plated layer formed on the semi-glossy nickel plated layer. Furthermore, the laser etched layer may be formed by laser etching a graphic on the nickel plated layer. (Second step, b) The thickness of the laser etched layer may be about 0.001 to 100 nm. Additionally, brightness of the graphic may be controlled by the thickness of the laser etched layer, and when the thickness etched in the embodiment is substantially small, almost a completely glossy graphic may be etched on glossy background, but as thickening the etching thickness increases, the dim gloss graphic may become almost semi glossy due to the semi glossy nickel plated layer 120 below the glossy nickel plated layer 130. In other words, the gloss level of the graphic may be controlled by the etched thickness.

Furthermore, contaminants resulting from the laser etching process may be removed and the surface may be washed by ultrasonic washing and electrolytic degrease. (c) The electrolytic degrease is a method of washing the plated material as a cathode or an anode by electrolysis, and thus, plating quality may be maintained.

In addition, the chromium plated layer 150 may be formed on the laser etched layer 160 (Third step), and the MP nickel plated layer 140 may be formed on the laser etched layer 160 for corrosion current dispersion followed by forming the chromium plated layer 150 and the like. (d) On the other hand, due to the substantially small thickness of the MP nickel plated layer 140 and the chromium plated layer 150, the exposure of the graphic etched on the laser etched layer 160 may not be affected, and the desired graphic may be obtained by the laser etching process without decreasing appearance, corrosion resistance, wear resistance and the like because the plating, wherein the graphic is etched on a glossy background, is completed by forming the common plated layer after laser etching the glossy nickel plated layer 130.

Further, when the chromium plated layer 150 is a colored chromium plated layer 150 such as a white chromium plated layer or a dark chromium plated layer, various coloring effect may be obtained due to the chromium plated layer 150 not being affected by the laser etching process.

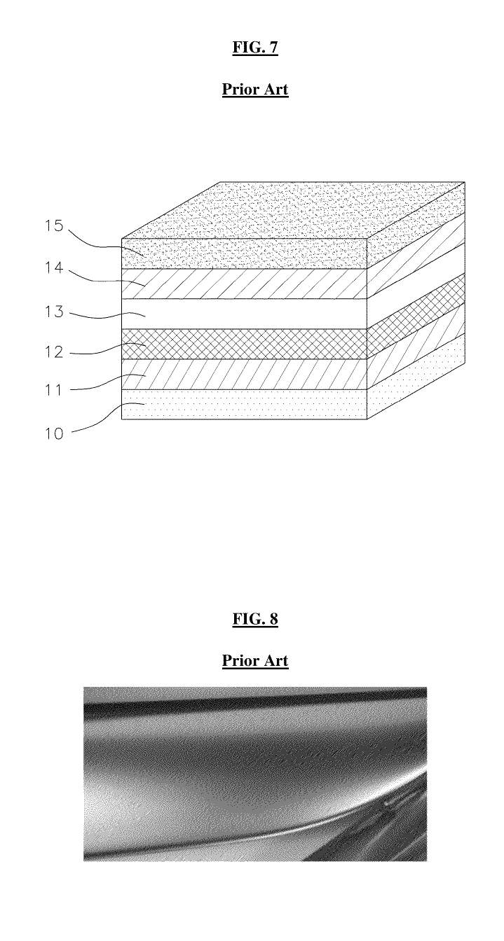

FIG. 7 is an exemplary schematic diagram showing the plated structure according to the conventional matte chromium plating method, and FIG. 8 is an exemplary diagram showing an embodiment according to the conventional matte chromium plating method.

As shown in FIG. 7 and FIG. 8, the plating by the conventional matte chromium plating method the raw material 20 showed gloss on the matte nickel plated layer 23 formed on the semi glossy nickel plated layer 22, and when a graphic was etched by the laser etching process on the chromium plated layer 25, appearance, corrosion resistance, wear resistance and the like decreased due to the chromium plated layer 25 or the MP nickel plated layer 24 being removed. In addition, when the chromium plated layer 25 was a colored chromium plated layer 25 such as a white chromium plated layer or a dark chromium plated layer, the desired color effect was not obtained because the colored chromium plated layer 25 was removed by the laser etching process.

However, the plating method according to the present invention may include a graphic without decreasing appearance, corrosion resistance, wear resistance and the like by forming a laser etched layer by laser etching the nickel plated layer, (e.g., the monolayered nickel plated layer such as the glossy nickel plated layer, the semi glossy nickel plated layer or the matte nickel plated layer, or on the multilayered nickel plated layer) followed by forming a common plated layer on the laser etched layer. The common plated layer may be a chromium plated layer, and it may include a MP nickel plated layer, a chromium plated layer formed on the MP nickel plated layer, and the like.

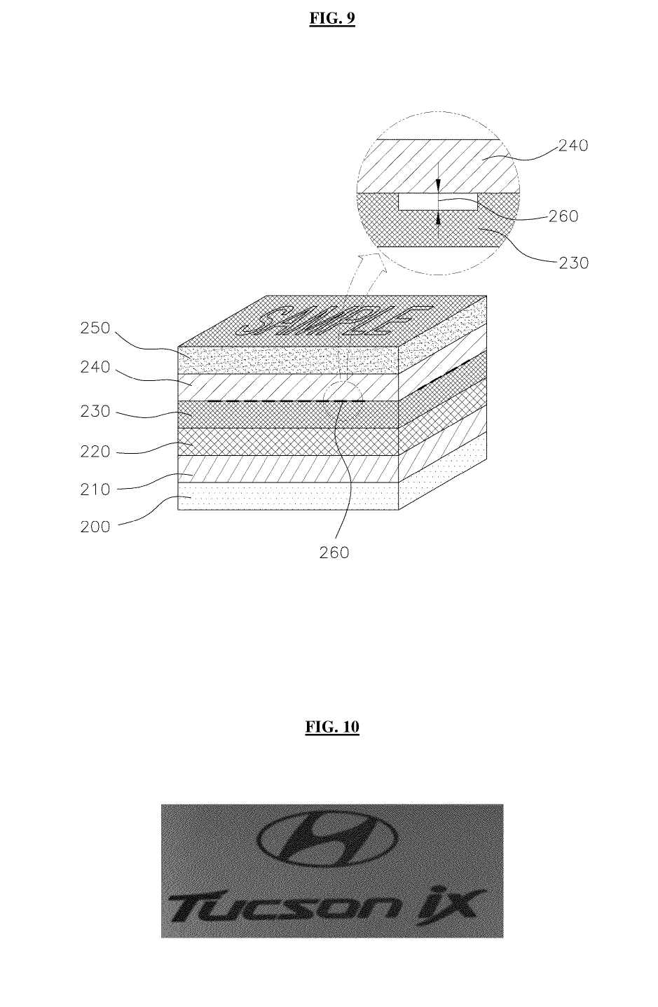

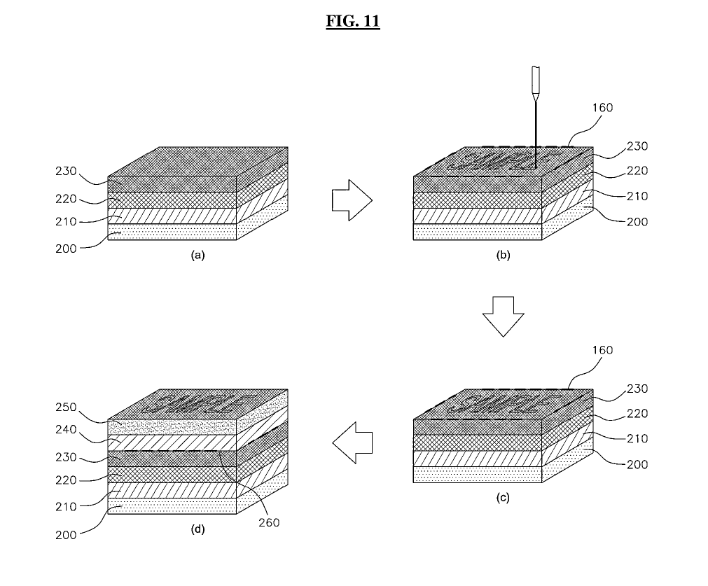

FIG. 9 is an exemplary schematic diagram showing a plated structure as one embodiment of the present invention, wherein a graphic is etched on matte background using a laser etching process on a multilayered nickel plated layer comprising a semi glossy nickel plated layer and a matte nickel plated layer formed on the semi glossy nickel plated layer, and the enlarged laser etched layer, and FIG. 10 is an exemplary diagram showing a graphic on matte background according to an exemplary embodiment of the present invention.

As shown in FIG. 9 and FIG. 10, a graphic may be etched on matte background without decreasing appearance, corrosion resistance, wear resistance and the like by forming a laser etched layer 260 laser etching a glossy nickel plated layer 230 and by forming a common plated layer such as a chromium plated layer 250 on the laser etched layer 260.

FIG. 11 is an exemplary diagram showing methods of a laser etching process, ultrasonic washing and electrolytic degrease of the multilayered-nickel plated layer comprising a matte nickel plated layer 230 as one embodiment of the present invention.

The nickel plated layer may be formed on the surface of the raw material 200, and a copper plated layer 210 may be formed on the surface of the raw material 200 for buffering performance absorbing impact, prior to forming the nickel plated layer. (First step, a) The nickel plated layer of FIG. 11 may be a multilayered nickel plated layer comprising a semi glossy nickel plated layer and a matte nickel plated layer formed on the semi glossy nickel plated layer. Further, the laser etched layer 260 may be formed by laser etching a graphic on the nickel plated layer. (Second step, b)

Moreover, the thickness of the laser etched layer formed by the laser etching process may be about 0.001 to 100 nm. The brightness of the graphic may be controlled by the thickness of the laser etched layer, and when the thickness etched in the embodiment is substantially small, almost a completely matte graphic may be etched on the matte background, but as the etching thickness increases, the dim matte graphic may become almost semi glossy due to the semi glossy nickel plated layer 220 below the matte nickel plated layer 230. In other words, the matte level of the graphic may be controlled by the etched thickness.

In addition, contaminants resulting from the laser etching process may be removed and the surface may be washed by ultrasonic washing and electrolytic degrease. (c) The electrolytic degrease is a method of washing the plated article as a cathode or an anode by electrolysis, and through the process, plating quality may be maintained.

Furthermore, the chromium plated layer 250 may be formed on the laser etched layer 260 (Third step), and the MP nickel plated layer 240 may be formed on the laser etched layer 260 for corrosion current dispersion followed by forming the chromium plated layer 250 and the like. (d)

On the other hand, due to a substantially small thickness of the MP nickel plated layer 240 and the chromium plated layer 250, the exposure of the graphic etched on laser etched layer 260 may be unaffected, and the desired graphic may be obtained by the laser etching process without decreasing appearance, corrosion resistance, wear resistance and the like because the plating, wherein the graphic is etched on a matte background, may be completed by forming the common plated layer after laser etching the glossy nickel plated layer 230. Further, when the chromium plated layer 250 is a colored chromium plated layer 250 such as a white chromium plated layer or a dark chromium plated layer, various coloring effect may be obtained because the chromium plated layer 250 is not affected by the laser etching process.

In the surface treatment method, of the present invention a laser etching process may etch a desired graphic onto a material layer without decreasing appearance, corrosion resistance, wear resistance and the like by laser etching a nickel plated layer followed by forming a common plated layer on the laser etched layer, and not laser etching the material surface.

Further, when considering relative importance of external appearance of products for customer product selection, as controlling brightness of the graphic according to the etched thickness of the nickel plated layer, merchantability, enhancing and upgrading product image may increase and thus a distinguished brand image may be produced.

The invention has been described in detail with reference to exemplary embodiments thereof. However, it will be appreciated by those skilled in the art that changes or modifications may be made in these embodiments without departing from the principles and spirit of the invention, the scope of which is defined in the accompanying claims and their equivalents.

What is claimed is:

1. A method for plating metal on the surface of a material, using a laser etching process comprising:
forming a nickel plated layer on the surface of a raw material;
forming a laser etched layer by laser etching a graphic on the nickel plated layer; and
forming a chromium plated layer on the laser etched layer.

2. The plating method of claim 1, wherein forming a laser etched layer further comprises removing a plurality of contaminants resulting from the laser etching and washing the surface by ultrasonic washing and electrolytic degrease after forming the laser etched layer.

3. The plating method of claim 1, wherein forming a nickel plated layer further comprises forming a copper plated layer on the surface of the raw material prior to forming the nickel plated layer.

4. The plating method of claim 1, wherein forming a chromium plated layer further comprises forming a MP (microporous) nickel plated layer on the laser etched layer prior to forming the chromium plated layer.

5. The plating method of claim 4, wherein forming the nickel plated layer further comprises forming a copper plated layer on the surface of the raw material prior to forming the nickel plated layer.

6. The plating method of claim 1, wherein the nickel plated layer is selected from a group consisting of: a glossy nickel plated layer, a semi glossy nickel plated layer, and a matte nickel plated layer.

7. The plating method of claim 1, wherein the nickel plated layer comprises a semi glossy nickel plated layer and a glossy nickel plated layer formed on the semi glossy nickel plated layer.

8. The plating method of claim 1, wherein the nickel plated layer comprises a semi glossy nickel plated layer and a matte nickel plated layer formed on the semi glossy nickel plated layer.

9. The plating method of claim 1, wherein the nickel plated layer comprises a semi glossy nickel plated layer, a glossy nickel plated layer formed on the semi glossy nickel plated layer and a matte nickel plated layer formed on the glossy nickel plated layer.

10. The plating method of claim 1, wherein the nickel plated layer comprises a semi glossy nickel plated layer, a matte nickel plated layer formed on the semi glossy nickel plated layer and a glossy nickel plated layer formed on the matte nickel plated layer.

11. The plating method of claim 1, wherein thickness of the laser etched layer is about 0.001 to 100 μm.

12. The plating method of claim 1, wherein the chromium plated layer is a white chromium plated layer or a dark chromium plated layer.
